(19) United States
(12) Patent Application Publication
(10) Pub. No.: US 2024/0140464 A1
(43) Pub. Date: May 2, 2024

(54) CONTROL DEVICE

(71) Applicant: KABUSHIKI KAISHA TOKAI RIKA DENKI SEISAKUSHO, Aichi (JP)

(72) Inventor: Masaki HYODO, Aichi (JP)

(73) Assignee: KABUSHIKI KAISHA TOKAI RIKA DENKI SEISAKUSHO, Aichi (JP)

(21) Appl. No.: 18/272,185

(22) PCT Filed: Dec. 22, 2021
(86) PCT No.: PCT/JP2021/047670

§ 371 Date: Jul. 13, 2023

(30) Foreign Application Priority Data
Jan. 18, 2021 (JP) 2021-005853

(51) Int. Cl. B60W 50/14; B60K 35/21; B60W 30/182; B60W 60/00

(52) U.S. Cl. CPC B60W 50/14; B60K 35/21; B60W 30/182; B60W 60/0051; B60K 2360/782; B60W 2540/223

(57) ABSTRACT

A control device is configured to control a light emitter installed in a steering device of a vehicle capable of traveling with a manual driving mode and a self-driving mode. A reception interface is configured to receive a first transition information relating to a transition from a manual driving mode to a self-driving mode in the vehicle, and a second transition information related to a transition from the self-driving mode to the manual driving mode in the vehicle. A processor is configured to cause, based on the first transition information, the light emitter to emit light in a first manner, and to cause, based on the second transition information, the light emitter to emit light in a second manner different from the first manner.

### TECHNICAL FIELD

The presently disclosed subject matter relates to a control device configured to control a light emitter installed in a steering device.

### BACKGROUND ART

Japanese Patent Publication No. 2014-69671 discloses a steering device equipped with a steering wheel equipped with a light emitter. The light emitter is controlled to emit light when the vehicle is traveling in the self-driving mode.

### SUMMARY OF INVENTION

### Technical Problem

It is demanded to have a user intuitively grasp the driving state of the mobile entity using a light emitter installed in the steering device.

### Solution to Problem

In order to meet the above demand, a first aspect of the presently-disclosed subject matter provides a control device configured to control a light emitter installed in a steering device of a mobile entity capable of traveling with a first driving mode and a second driving mode, comprising:
a reception interface configured to receive a first transition information relating to a transition from a first driving mode to a second driving mode in the mobile entity, and a second transition information related to a transition from the second driving mode to the first driving mode in the mobile entity; and
a processor configured to cause, based on the first transition information, the light emitter to emit light in a first manner, and to cause, based on the second transition information, the light emitter to emit light in a second manner different from the first manner.

According to the configuration according to the above aspect, the light emission mode of the light emitter is different between the time when the mobile entity changes from the first driving mode to the second driving mode and the time when the mobile entity changes from the second driving mode to the first driving mode, so that the user of the mobile entity can intuitively recognize which driving mode is enabled. As a result, the user can intuitively grasp the driving state of the mobile entity.

In order to meet the above demand, a second aspect of the presently-disclosed subject matter provides a control device configured to control a light emitter installed in a steering device of a mobile entity capable of traveling with a plurality of driving modes, comprising:
a reception interface configured to receive transition information relating to a transition between the plurality of driving modes in the mobile entity, and a continuation information relating to a continuation of any one of the plurality of driving modes in the mobile entity; and
a processor configured to cause, based on the transition information, the light emitter to emit light in a first manner, and to cause, based on the continuation information, the light emitter to emit light in a second manner different from the first manner.

According to the configuration according to the above aspect, the light emission mode of the light emitter is different between the time when the driving mode changes and the time when the driving mode is continued in a plurality of driving modes in the mobile entity, so that the user of the mobile entity can intuitively recognize the state between the transition of the driving mode and the continuation of the driving mode. As a result, the user can intuitively grasp the driving state of the mobile entity.

### BRIEF DESCRIPTION OF DRAWINGS

FIG. 1 illustrates an exemplary functional configuration of a control device according to an embodiment.

FIG. 2 illustrates a vehicle in which the control device of FIG. 1 is to be installed.

FIG. 3 illustrates a light emitter to be controlled by the control device of FIG. 1.

FIG. 4 illustrates a light emitter to be controlled by the control device of FIG. 1.

FIG. 5A illustrates the operation of the light emitter of FIG. 3.

FIG. 5B illustrates the operation of the light emitter of FIG. 3.

FIG. 5C illustrates the operation of the light emitter of FIG. 3.

FIG. 6 illustrates the operation of the light emitter of FIG. 3.

FIG. 7A illustrates the operation of the light emitter of FIG. 4.

FIG. 7B illustrates the operation of the light emitter of FIG. 4.

FIG. 7C illustrates the operation of the light emitter of FIG. 4.

FIG. 8 illustrates the operation of the light emitter of FIG. 3.

FIG. 9 illustrates another exemplary functional configuration of a control device of FIG. 1.

### DESCRIPTION OF EMBODIMENTS

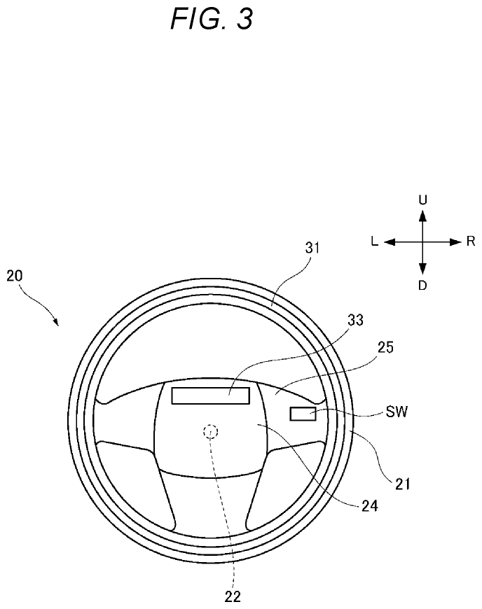

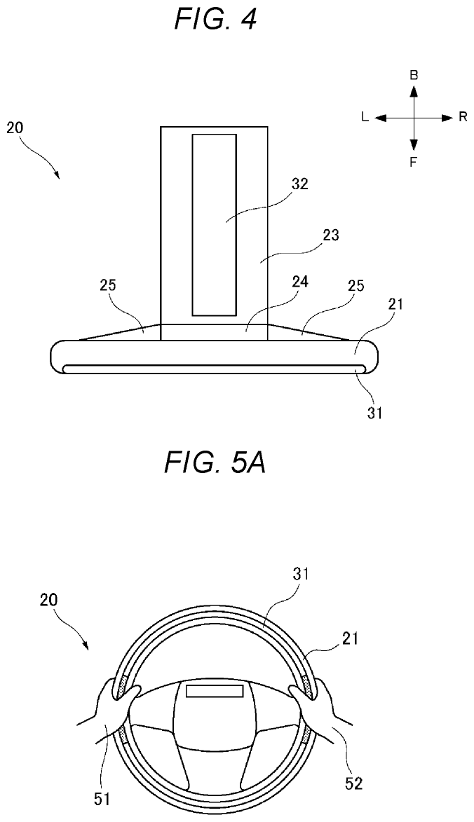

Exemplary embodiments will be described in detail below with reference to the accompanying drawings. In each of the drawings, the scale is appropriately changed in order to make each of the members have a recognizable size. In FIGS. 3 and 4, an arrow U represents an upward direction of an illustrated structure. An arrow D represents a downward direction of an illustrated structure. An arrow F represents a forward direction of an illustrated structure. An arrow B represents a rearward direction of an illustrated structure. An arrow L represents a left direction of an illustrated structure. An arrow R represents a right direction of an illustrated structure. The expressions “front”, “rear”, “upper”, “lower”, “left” and “right” are used for convenience in facilitating understanding of the illustrated structure, and are not intended to limit the direction or posture of the structure during actual use.

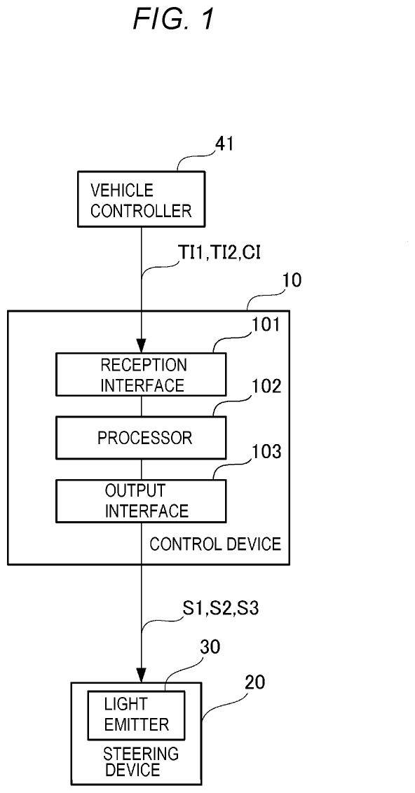

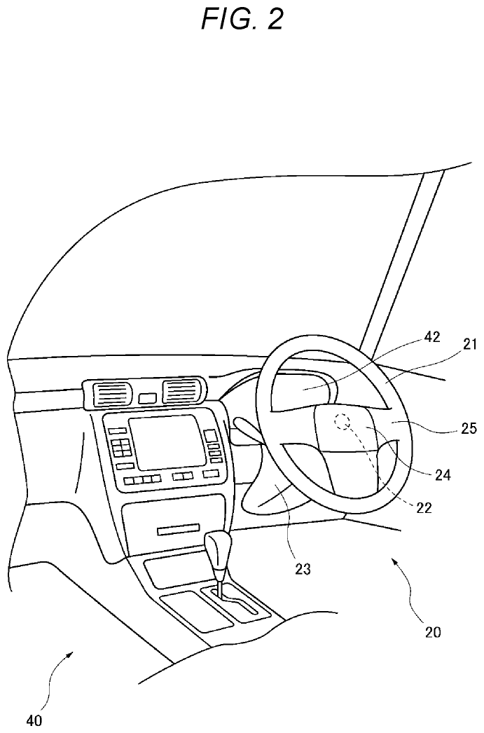

FIG. 1 illustrates a specific functional configuration of a control device 10 according to an embodiment. The control device 10 controls a light emitter 30 installed in a steering device 20. The steering device 20 is installed in a vehicle 40 illustrated in FIG. 2. The steering device 20 is a device for performing an operation of changing the traveling direction of the vehicle 40. The light emitter 30 is configured to emit light in a mode corresponding to the driving state of the vehicle 40. The control device 10 may be installed in the steering device 20, or may be installed in a different location in the vehicle 40 from the steering device 20. The vehicle 40 is an example of a mobile entity.

As illustrated in FIG. 2, the steering device 20 includes a grip portion 21, a shaft portion 22, a column portion 23, a hub portion 24, and an arm portion 25. The grip portion 21 can be gripped by a driver of the vehicle 40. In this example, the grip portion 21 has an annular shape. The shaft portion 22 is rotatable by the grip portion 21. The rotation of the shaft portion 22 is associated with an operation of changing the course of the vehicle 40. The column portion 23 is disposed between the grip portion 21 and a meter panel 42, and covers the shaft portion 22. The hub portion 24 is connected to the shaft portion 22. The arm portion 25 connects the grip portion 21 and the hub portion 24 to each other. The hub portion 24 is an example of a portion connecting the grip portion 21 and the shaft portion 22.

As illustrated in FIGS. 3 and 4, the light emitter 30 includes a first light emitter 31, a second light emitter 32, and a third light emitter 33. The first light emitter 31 is provided on the grip portion 21. In this example, the first light emitter 31 has an annular shape extending along the circumferential direction of the grip portion 21 on the front surface of the grip portion 21. The second light emitter 32 is provided in the column portion 23. In this example, the second light emitter 32 extends along the front-rear direction at the center of the upper surface of the column portion 23. The third light emitter 33 is provided in the hub portion 24. In this example, the third light emitter 33 extends in the left-right direction above the front surface of the hub portion 24 at the initial position of the grip portion 21.

The first light emitter 31 includes a plurality of semiconductor light emitting elements capable of emitting a single color or a plurality of colors. For example, the first light emitter 31 may include a plurality of semiconductor light emitting elements arranged along the circumferential direction of the grip portion 21. Similarly, the second light emitter 32 and the third light emitter 33 include a plurality of semiconductor light emitting elements capable of emitting a single color or a plurality of colors. For example, the second light emitter 32 may include a plurality of semiconductor light emitting elements arranged along the front-rear direction of the column portion 23. For example, the third light emitter 33 may include a plurality of semiconductor light emitting elements arranged along the left-right direction of the hub portion 24. Examples of the semiconductor light emitting element include a light emitting diode, a laser diode, and an EL element.

The vehicle 40 on which the control device 10 according to the present embodiment is installed is configured to be capable of traveling in a manual driving mode and traveling in an self-driving mode. As used herein, the term “self-driving” means that the vehicle 40 exhibits a driving support function. As used herein, the term “driving support” means control processing that at least partially performs at least one of driving operation (steering operation, acceleration, deceleration), monitoring of a traveling environment, and backup of driving operation. That is, the term “driving support” includes not only a partial driving support such as a collision avoidance braking system function and a lane keeping assist function, but also a full self-driving operation. As used herein, the term “manual driving” means a state in which the driving support as described above is disabled.

As illustrated in FIG. 1, the control device 10 includes a reception interface 101 and a processor 102. The reception interface 101 is configured as an interface capable of receiving first transition information TI1 relating to the transition from the manual driving mode to the self-driving mode in the vehicle 40, and second transition information TI2 relating to the transition from the self-driving mode to the manual driving mode. The first transition information TI1 and the second transition information TI2 can be acquired from a vehicle controller 41 for controlling the driving of the vehicle 40. The manual driving mode is an example of the first driving mode. The self-driving mode is an example of the second driving mode.

In a case where the first transition information TI1 and the second transition information TI2 are in the form of analog data, the reception interface 101 includes an appropriate conversion circuit including an A/D converter. The processor 102 sets the first transition information TI1 and the second transition information TI2 in the form of digital data as processing targets.

The processor 102 is configured to output a first light emitting signal S1 for causing the light emitter 30 to emit light in a first manner based on the first transition information TI1 to the output interface 103. In addition, the processor 102 is configured to cause the output interface 103 to output a second light emitting signal S2 for causing the light emitter 30 to emit light in a second mode different from the first mode based on the second transition information TI2.

Each of the first light emitting signal S1 and the second light emitting signal S2 may be an analog signal or a digital signal. In a case where each of the first light emitting signal S1 and the second light emitting signal S2 is an analog signal, the output interface 103 includes an appropriate conversion circuit including a D/A converter.

The light emission of the first embodiment and the light emission of the second embodiment can be set so that at least one of a light emitting color, a light emitting area, a light emitting time length, and a ratio of the light emitting time length to the non-light emitting time length is different from each other.

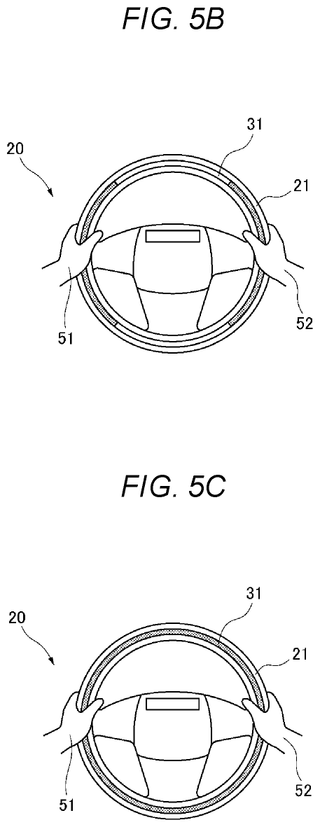

For example, as illustrated in FIGS. 5A to 5C, the processor 102 may cause the first light emitter 31 to emit light in a first manner so that the light emitting area extends in the circumferential direction from the position gripped by the driver based on the first transition information TI1.

As illustrated in FIG. 5A, when the first transition information TT′ is accepted by the reception interface 101, the processor 102 causes the output interface 103 to output a first light emitting signal S1 for controlling the light emitter 30 such that one or more light emitting elements corresponding to the positions gripped by the left hand 51 and the right hand 52 of the driver in the plurality of light emitting elements constituting the first light emitter 31 emit light. The gripping position information corresponding to the position gripped by the left hand 51 and the right hand 52 of the driver can be acquired from a gripping sensor provided in the grip portion 21, a camera provided in the internal space of the vehicle 40, or the like. Based on the gripping position information accepted by the reception interface 101, the processor 102 can specify one or more light emitting elements corresponding to the position gripped by the left hand 51 and the right hand 52 of the driver.

As illustrated in FIGS. 5B and 5C, the processor 102 causes the output interface 103 to output a first light emitting signal S1 for controlling the light emitter 30 so that the plurality of light emitting elements constituting the first light emitter 31 emit light sequentially along the circumferential direction of the grip 21 from the position gripped by the left hand 51 and the right hand 52 of the driver.

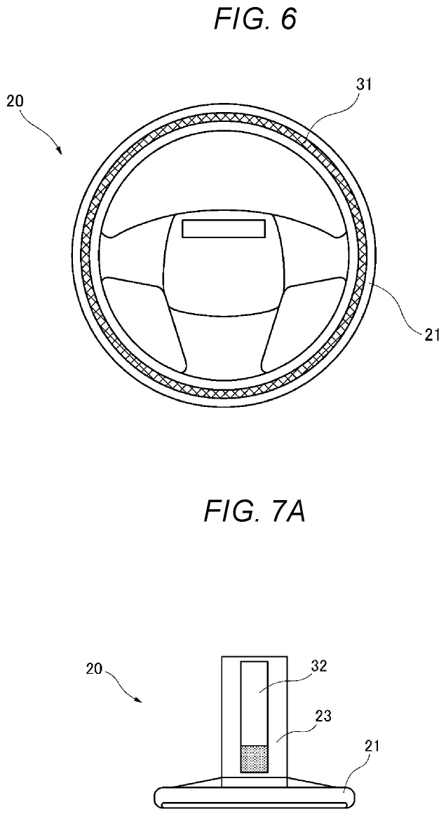

As illustrated in FIG. 6, the processor 102 may cause the first light emitter 31 to emit light in the second manner so that the entire light emitting area extending along the circumferential direction emits light based on the second transition information TI2. That is, the processor 102 causes the output interface 103 to output a second light emitting signal S2 for controlling the light emitter 30 so that all of the plurality of light emitting elements constituting the first light emitter 31 emit light.

According to the configuration as described above, since the light emission mode of the light emitter 30 is different between the time when the vehicle 40 changes from the manual driving mode to the self-driving mode and the time when the vehicle 40 changes from the self-driving mode to the manual driving mode, the driver of the vehicle 40 can intuitively recognize which driving mode is enabled.

In the present embodiment, based on the first transition information TI1 indicating the transition from the manual driving mode to the self-driving mode, the first light emitter 31 is caused to emit light such that the light emitting area extends in the circumferential direction from the position gripped by the driver. As a result, it is possible to give the driver an impression that the control of the steering device 20 is transferred to the vehicle 40. Accordingly, the driver can recognize that the subject of the driving operation of the vehicle 40 shifts from the driver to the vehicle 40.

In the present embodiment, the entire light emitting area in the circumferential direction is caused to emit light in the first light emitter 31 based on the second transition information TI2 indicating the transition from the self-driving mode to the manual driving mode. As a result, it is possible to give the driver an impression that the grip on the grip portion 21 is demanded. Accordingly, the driver can recognize that the subject of the driving operation of the vehicle 40 shifts from the vehicle 40 to the driver.

In the present embodiment, the processor 102 causes the first light emitter 31 provided in the grip portion 21 to emit light based on the first transition information TI1. However, the processor 102 may cause the second light emitter 32 provided in the column portion 23 to emit light based on the first transition information TI1 instead of or in addition to the first light emitter 31.

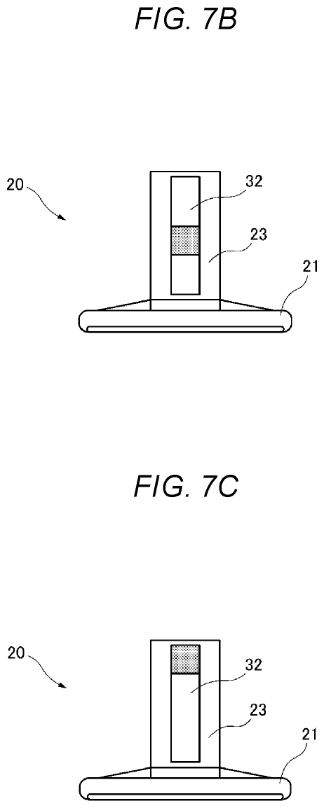

For example, as illustrated in FIGS. 7A to 7C, the processor 102 may cause the second light emitter 32 to emit light in a first manner so that the light emitting position moves toward the meter panel 42 of the vehicle 40 based on the first transition information TI1.

As illustrated in FIG. 7A, when the first transition information TI1 is accepted by the reception interface 101, the processor 102 causes the output interface 103 to output a first light emitting signal S1 for controlling the light emitter 30 such that one or more light emitting elements disposed near the hub portion 24 in the plurality of light emitting elements constituting the second light emitter 32 emit light.

As illustrated in FIGS. 7B and 7C, the processor 102 causes the output interface 103 to output a first light emitting signal S1 for controlling the light emitter 30 so that the plurality of light emitting elements constituting the second light emitter 32 emit light sequentially from the hub portion 24 toward the meter panel 42 of the vehicle 40.

According to such a configuration, based on the first transition information TI1 indicating the transition from the manual driving mode to the self-driving mode, the second light emitter 32 is caused to emit light such that the light emitting position moves toward the meter panel 42 of the vehicle 40 instead of or in addition to the first light emitter 31. As a result, it is possible to give the driver an impression that the control of the steering device 20 is transferred from the driver to the vehicle 40. Accordingly, the driver can recognize that the subject of the driving operation of the vehicle 40 shifts from the driver to the vehicle 40.

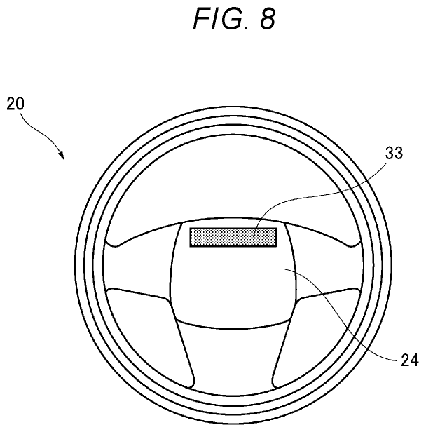

As illustrated in FIG. 1, the reception interface 101 may be configured to accept continuation information CI relating to the continuation of the traveling in the self-driving mode. The processor 102 may be configured to output the third light emitting signal S3 to the output interface 103 based on the continuation information CI. For example, as illustrated in FIG. 8, the processor 102 causes the output interface 103 to output a third light emitting signal S3 for controlling the light emitter 30 so that all of the plurality of light emitting elements constituting the third light emitter 33 emit light based on the continuation information CI. That is, the third light emitting signal S3 causes the light emitter 30 to emit light in a third manner different from the first mode and the second mode.

According to such a configuration, the driver of the vehicle 40 can also recognize that the traveling state in the self-driving mode after the transition is continued by the light emitted from the light emitter 30 in the third mode.

In addition, since the third light emitter 33 provided in the hub portion 24 different from the grip portion 21 and the column portion 23 emits light based on the continuation information CI, it is possible to give an impression that the control of the steering device 20 is continued to the driver.

In the present embodiment, the light emission mode of the light emitter 30 is made different from each other by making the light emitting area of the light emitter 30 different from each other. However, in place of or in addition to the light emitting area, the light emitting color, the light emitting time length, the light emitting cycle, and the like of the light emitter 30 can be made different from each other, thereby causing the light emitting mode of the light emitter 30 to be different from each other. For example, the processor 102 may control the first light emitter 31 or the second light emitter 32 to be turned on in green based on the first transition information TI1. In addition, the processor 102 may control the third light emitter 33 to be turned on in green based on the continuation information CI. By lighting the light emitter 30 in green, it is possible to give the driver a sense of safety. On the other hand, the processor 102 may control the first light emitter 31 to blink red based on the second transition information TI2. When the light emitter 30 blinks red, the driver can feel urgency and prompt the grip of the grip portion 21 quickly.

In the present embodiment, the control device 10 causes the light emitter 30 to emit light in a different manner when the transition from the first driving mode to the second driving mode, the transition from the second driving mode to the first driving mode, or the driving state in the second driving mode after the transition continues. However, for example, the control device 10 may cause the light emitter 30 to emit light in a different manner during a transition between a plurality of driving modes and a continuation of any one of the plurality of driving modes.

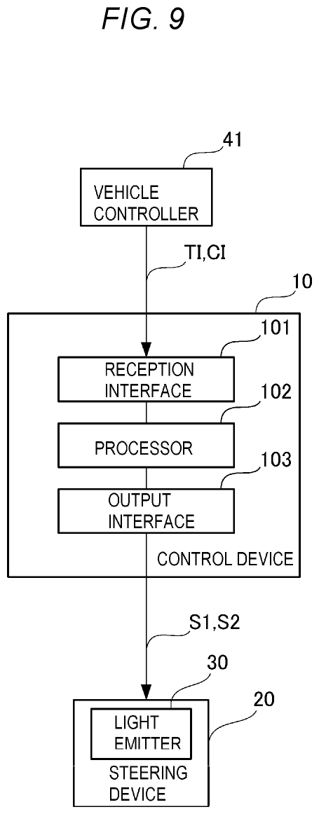

For example, as illustrated in FIG. 9, the reception interface 101 may be configured as an interface capable of receiving transition information TI relating to a transition between a plurality of driving modes in the vehicle 40, and continuation information CI relating to the continuation of any one of the plurality of driving modes in the vehicle 40. The transition information TI and the continuation information CI can be acquired from the vehicle controller 41.

The processor 102 may be configured to output a first light emitting signal S1 for causing the light emitter 30 to emit light in a first manner, to the output interface 103 based on the transition information TI. In addition, the processor 102 may be configured to output a second light emitting signal S2 for causing the light emitter 30 to emit light in a second mode different from the first mode, to the output interface 103 based on the continuation information CI.

For example, the processor 102 may cause at least one of the first light emitter 31 provided in the grip portion 21 and the second light emitter 32 provided in the column portion 23 of the steering device 20 to emit light in the first manner based on the transition information TI, and may cause the third light emitter 33 provided in the hub portion 24 to emit light in the second manner based on the continuation information CI. That is, the processor 102 causes the output interface 103 to output a first light emitting signal S1 for controlling the light emitter 30 so that a plurality of light emitting elements constituting at least one of the first light emitter 31 and the second light emitter 32 emit light. In addition, the processor 102 causes the output interface 103 to output a second light emitting signal S2 for controlling the light emitter 30 so that a plurality of light emitting elements constituting the third light emitter 33 emit light.

According to such a configuration, the driver of the vehicle 40 can intuitively recognize the driving mode enabled in the vehicle 40. That is, since the light emission mode of the light emitter 30 is different between when the driving mode changes and when the driving mode that is enabled is continued in a plurality of driving modes in the vehicle 40, the user of the vehicle 40 can intuitively recognize whether the state is the transition of the driving mode or the continuation of the driving mode.

The processor 102 having each function described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a storage medium having stored a computer program. The general-purpose microprocessor designates at least a part of the computer program stored in the ROM, loads the program on the RAM, and executes the processing described above in cooperation with the RAM. The above-described computer program may be pre-installed in the general-purpose memory, or may be downloaded from an external server device via a wireless communication network and then installed in the general-purpose memory. In this case, the external server device is an example of a storage medium having stored a computer program.

The processor 102 may be implemented by an exclusive integrated circuit capable of executing the above-described computer program, such as a microcontroller, an ASIC, and an FPGA. In this case, the above-described computer program is pre-installed in a memory element included in the exclusive integrated circuit. The memory element is an example of a storage medium having stored a computer program. The processor 102 may also be implemented by a combination of a general-purpose microprocessor and an exclusive integrated circuit.

The above embodiments are merely illustrative for facilitating understanding of the gist of the presently disclosed subject matter. The configuration according to each of the above embodiments can be appropriately modified or changed without departing from the gist of the presently disclosed subject matter.

In the example of the above embodiment, the first light emitter 31 has an annular shape corresponding to the shape of the grip portion 21. However, the shape of the first light emitter 31 may be appropriately changed in accordance with the shape of the grip portion 21. Even in a case where the first light emitter 31 does not have an annular shape, by causing the first light emitter 31 to emit light so that the light emitting area is enlarged from the position gripped by the driver based on the first transition information TI1, it is possible to give the user an impression that the control of the steering device 20 is transferred to the vehicle 40. In addition, by causing the entire light emitting area of the first light emitter 31 to emit light based on the second transition information TI2, it is possible to give the driver an impression that the grip on the grip portion 21 is demanded.

In the example of the above embodiment, the light emitter 30 is controlled such that the light emitting position moves from the hub portion 24 toward the meter panel 42 of the vehicle 40 in the second light emitter 32 based on the first transition information TI1. However, for example, the light emitter 30 may be configured to move the light emitting position from the driving mode switching switch SW disposed on the arm portion 25 illustrated in FIG. 3 to the meter panel 42 of the vehicle 40. Specifically, the light emitter 30 may be configured to have an additional light emitter between the driving mode switching switch SW and the second light emitter 32. By causing the light emitter and the second light emitter 32 to emit light in this order, the light emitting position can be moved from the driving mode switching switch SW toward the meter panel 42 of the vehicle 40.

In the above example embodiment, the processor 102 may be configured to output light emission stop information for stopping the light emission of the light emitter 30 from the output interface 103. The light emitter 30 may be configured to stop light emission based on the light emission stop information. For example, the processor 102 may output light emission stop information when a predetermined period of time elapses after the light emitter 30 emits light or based on an operation input from the driver.

In each of the above embodiments, the light emitter 30 includes the first light emitter 31, the second light emitter 32, and the third light emitter 33 as illustrated in FIGS. 3 and 4. However, the shape and the arrangement of the light emitter 30 may be appropriately determined. In addition, the light emitter 30 is configured by a plurality of semiconductor light emitting elements, but can be realized by another light emitting device such as a side-emitting type optical fiber.

The control device 10 may be installed in a steering device for changing the travelling direction of a mobile entity other than the vehicle 40. Examples of such mobile entities include railways, ships, and aircrafts.

The present application is based on Japanese Patent Application No. 2021-005853 filed on Jan. 18, 2021, the entire contents of which are incorporated herein by reference.

1. A control device configured to control a light emitter installed in a steering device of a mobile entity capable of traveling with a first driving mode and a second driving mode, comprising:
a reception interface configured to receive a first transition information relating to a transition from a first driving mode to a second driving mode in the mobile entity, and a second transition information related to a transition from the second driving mode to the first driving mode in the mobile entity; and
a processor configured to cause, based on the first transition information, the light emitter to emit light in a first manner, and to cause, based on the second transition information, the light emitter to emit light in a second manner different from the first manner.

2. The control device according to claim 1,
wherein the first driving mode is a manual driving mode and the second driving mode is a self-driving mode.

3. The control device according to claim 2,
wherein the first manner includes at least one of a manner which causes the light emitter provided on a grip portion capable of being gripped by a user in the steering device to emit light so that a light emitting area is enlarged from a position gripped by the user, and a manner in which causes the light emitter provided on a column portion covering a shaft portion rotatable by the grip portion in the steering device to emit light so that a light emitting position moves toward an information display device of the mobile entity.

4. The control device according to claim 2,
wherein the second manner includes a manner which causes an entire light emitting area of the light emitter provided on a grip portion capable of being gripped by a user in the steering device to emit light.

5. The control device according to claim 1,
wherein the reception interface is configured to receive a continuation information relating to a continuation of a traveling in the second driving mode, and
wherein the processor is configured to causes the light emitter to emit light in a third manner different from the first manner and the second manner, based on the continuation information.

6. The control device according to claim 5,
wherein the third manner includes a manner which causes the light emitter provided a portion connecting a grip portion capable of being gripped by a user in the steering device and a shaft portion rotatable by the grip portion to emit light.

7. A control device configured to control a light emitter installed in a steering device of a mobile entity capable of traveling with a plurality of driving modes, comprising:
a reception interface configured to receive a transition information relating to a transition between the plurality of driving modes in the mobile entity, and a continuation information relating to a continuation of any one of the plurality of driving modes in the mobile entity; and
a processor configured to cause, based on the transition information, the light emitter to emit light in a first manner, and to cause, based on the continuation information, the light emitter to emit light in a second manner different from the first manner.
